(19) United States
(12) Patent Application Publication
(10) Pub. No.: US 2024/0206028 A1
(43) Pub. Date: Jun. 20, 2024

(54) LOAD MEASURING DEVICE IN COOKING APPARATUS, AND CONTROL METHOD THEREOF

(71) Applicant: SAMSUNG ELECTRONICS CO., LTD., Suwon-si (KR)

(72) Inventors: Elijah KIM, Suwon-si (KR); Chunseong KIM, Suwon-si (KR); Byoungwoo KO, Suwon-si (KR); Haedeun KIM, Suwon-si (KR); Jinho JEONG, Suwon-si (KR); Jaewan HONG, Suwon-si (KR)

(73) Assignee: SAMSUNG ELECTRONICS CO., LTD., Suwon-si (KR)

(21) Appl. No.: 18/592,158

(22) Filed: Feb. 29, 2024

Related U.S. Application Data
(63) Continuation of application No. PCT/KR2022/015260, filed on Oct. 11, 2022.

(30) Foreign Application Priority Data
Dec. 13, 2021 (KR) 10-2021-0177477

(51) Int. Cl. H05B 6/64; G01G 19/52; G01G 21/22

(52) U.S. Cl. CPC H05B 6/6464; G01G 19/52; G01G 21/22; H05B 6/6411; H05B 6/642

(57) ABSTRACT

Provided in various embodiments of the present disclosure are a device for measuring the load of food materials put on a tray in a cooking apparatus, and a control method therefor. To this end, the cooking apparatus has a stick-shaped guide rod extending in the vertical direction toward the bottom of a cavity from the lower side of an accommodation tray to which each of a plurality of rollers making roll-contact with the bottom surface of the tray can be independently mounted, has a first coupling part formed on a load-transferring member such that the lower end portion of the guide rod is fitted and fixed therein, and generates an electrical signal in a load cell due to the load transferred by the load-transferring member. Other various embodiments are possible.

### CROSS-REFERENCE TO RELATED APPLICATIONS

This application is a continuation of International Application PCT/KR2022/015260, filed Oct. 11, 2022, and claims foreign priority to Korean application 10-2021-0177477, filed Dec. 13, 2021, the disclosures of which are incorporated herein by reference in their entireties.

### TECHNICAL FIELD

The disclosure relates to a device for measuring a load applied from a tray in a cooking device and a method for controlling the same.

### BACKGROUND ART

In general, cooking device refers to an electronic device that uses electricity to generate at least one of high frequency (or microwave), radiant heat, or convection heat to cook food or cooking ingredients (hereinafter collectively referred to as “cooking ingredient”). A representative example of the cooking device is a microwave oven. The microwave oven is a device that generates microwaves inside a cooking chamber and cooks cooking a cooking ingredient.

In addition to a high frequency heating device that generates high frequencies, a microwave oven is equipped with a grill device that supplies radiant heat or a convection device that supplies convection heat, and heats the cooking ingredient in various manners. The microwave oven has a function that provides recipes according to cooking ingredients using various heating sources. For example, the microwave oven may provide a function of heating the cooking ingredient using high frequency, baking the cooking ingredient using the grill device, or cooking the cooking ingredient using the convection device.

The cooking device which provides recipes using various heating sources such as high frequency, radiant heat, or convection requires precise weight measurement capable of predicting, e.g., the size or volume of a cooking ingredient as well as the type of the cooking ingredient or the state of the cooking ingredient, such as being solid, liquid, or frozen, so as to provide a more precise and detailed recipe.

### DETAILED DESCRIPTION OF THE INVENTION

### Technical Solution

Various embodiments of the disclosure provide a device for measuring a load due to a cooking ingredient put on a tray in a cooking device and a method for controlling the same.

A cooking device according to various embodiments of the disclosure may include a cavity including an opening, a tray disposed to place a cooking ingredient on an upper surface thereof inside the cavity, a guide roller member including a receiving tray in which a roller is mounted so as to be in rolling contact with a lower surface of the tray, and a guide rod extending in a vertical direction from a lower side of the receiving tray to a bottom of the cavity, a load transfer member including a plate having a first coupling portion on an upper surface of the plate so as to have an upper opening, wherein a lower end portion of the guide rod is fitted and fixed in the first coupling portion, a load cell having an upper surface in contact with a lower surface of the load transfer member, and configured to generate an electrical signal according to a load transferred through the guide rod and the load transfer member, and a bracket including at least two vertical surfaces that each has a fastening portion, at a first side end of the vertical surface, fastening the vertical surface with a lower surface of the cavity, a horizontal surface forming a bottom of the bracket and horizontally connecting second side ends of the at least two vertical surfaces, and a second coupling portion on the horizontal surface and having an upper opening, wherein the plate and the load cell are inserted in the second coupling portion.

According to various embodiments of the disclosure, the receiving tray is inside the cavity, the load transfer member and the load cell are outside the cavity, and the guide rod extends from the receiving tray, passes through the bottom of the cavity, and is inserted into the first coupling portion.

According to various embodiments of the disclosure, the guide rod has a hollow structure.

According to various embodiments of the disclosure, a size of a hole in the bottom of the cavity, through which the guide rod passes, is smaller than a wavelength of an electromagnetic wave generated in a microwave mode.

According to various embodiments of the disclosure, the guide roller member, the load transfer member, and the load cell are under the bottom of the cavity, and an upper end portion exposed outside the receiving tray in the roller mounted in the receiving tray passes through the bottom of the cavity and is in rolling contact with the lower surface of the tray.

According to various embodiments of the disclosure, the guide rod has a hollow structure having a hole in a longitudinal direction of the guide rod, the cooking device further includes an elastic member which has an upper end portion fitted into the hole of the guide rod and a lower end portion fitted into the first coupling portion.

According to various embodiments of the disclosure, the elastic member is a coil spring.

According to various embodiments of the disclosure, the guide rod has a hollow structure having a hole in a longitudinal direction of the guide rod, and the cooking device further includes a bolt which passes through a bottom of the first coupling portion and is inserted into the hole.

According to various embodiments of the disclosure, the cooking device may further include a plurality of rollers mounted in the guide roller member, wherein first side ends of two opposite side ends of load transfer members provided corresponding to the plurality of rollers, respectively, are gathered in a substantial center direction, and the load cell is disposed at a position where the first side ends of the load transfer members are gathered.

According to various embodiments of the disclosure, the cooking device may further include a cooling fan outside a ceiling of the cavity, and a cooling passage having a first side end coupled with the cooling fan and a second side end disposed downward of the bottom of the cavity where the load cell is positioned to form a passage for supplying cooling air created by the cooling fan to the load cell.

According to various embodiments of the disclosure, a first side end of a cooling passage upper member is fitted into a first side end of a cooling passage lower member.

According to various embodiments of the disclosure, the roller has a wheel shape.

According to various embodiments of the disclosure, the roller has a ball shape.

A cooking device according to various embodiments of the disclosure may include a cavity including an opening, a tray disposed to place a cooking ingredient on an upper surface of the tray inside the cavity, a support plate facing the tray and under the tray, and having a first coupling portion having a lower opening toward a bottom of the cavity in a lower surface of the support plate, a plurality of rollers in rolling contact between the tray and the support plate, a roller guide horizontally extending from a rotation shaft positioned in a substantial center of the tray and configured to allow the plurality of rollers to rotate along a predetermined concentric circle, a guide injection-molded article having a second coupling portion with an upper opening and a predetermined length on an upper surface of a plate with a predetermined thickness, formed so that the open surfaces of the second coupling portion and the first coupling portion are disposed to face each other on a vertical axis, an elastic member having an upper end portion fitted into the first coupling portion and a lower end portion fitted over the second coupling portion, and a load cell having the guide injection-molded article on an upper surface thereof so that a lower surface of the guide injection-molded article contacts the upper surface of the load cell, and configured to generate an electrical signal according to a load transferred through the support plate, the elastic member and the guide injection-molded article.

According to various embodiments of the disclosure, the cooking device may further include a cell fixing member disposed between a lower surface of the load cell and a bottom and configured to support the load cell from the bottom.

According to various embodiments of the disclosure, the cooking device may further include a protruding coupling portion fitted into a lower end of the elastic member near a center of the second coupling portion.

According to various embodiments of the disclosure, the protruding coupling portion has a rod shape or a button shape.

According to various embodiments of the disclosure, the cooking device may further include a sensor housing that houses the guide injection-molded article and the load cell.

According to various embodiments of the disclosure, the sensor housing has a hole through which the second coupling portion passes upward along a vertical axis.

According to various embodiments of the disclosure, each roller of the plurality of rollers has a wheel shape or a ball shape.

According to various embodiments of the disclosure, it is possible to provide user convenience and prevent damage to the sensor provided for measuring weight due to heat during cooking as the cooking device indicates a reliable cooking ingredient weight.

### BRIEF DESCRIPTION OF DRAWINGS

FIG. 1 is a perspective view illustrating a cooking device according to various embodiments;

FIG. 2 is a view illustrating an example of a tray assembly in a cooking device according to various embodiments;

FIG. 3 is a cross-sectional view taken along A-A′ of the third load measuring member 200 of FIG. 2;

FIG. 4 is a perspective view illustrating the third load measuring member of FIG. 3;

FIG. 5 is an exploded perspective view illustrating the third load measuring member of FIG. 3;

FIG. 6 is a view illustrating another example of a tray assembly in a cooking device according to various embodiments;

FIG. 7 is a cross-sectional view taken along B-B′ of the third load measuring member of FIG. 6;

FIG. 8 is a perspective view illustrating the third load measuring member 600 of FIG. 6;

FIG. 9 is an exploded perspective view illustrating the third load measuring member 600 of FIG. 6;

FIG. 10 is a view illustrating an example design of a guide roller member in a cooking device according to an embodiment;

FIG. 11 illustrates (a) a cross-sectional view illustrating a cavity in a cooking device and (b) a view illustrating an example in which a load due to a cooking ingredient placed on a tray is transferred to a load cell according to various embodiments;

FIG. 12 is a view illustrating another example of a tray assembly in a cooking device according to various embodiments;

FIG. 13 is a cross-sectional view taken along C-C′ in the tray assembly shown in FIG. 12;

FIG. 14 is a view illustrating a structure of a load transfer assembly in a tray assembly of a cooking device according to an embodiment;

FIG. 15 is another example cross-sectional view taken along B-B′ of the third load measuring member of FIG. 6;

FIG. 16 is an example view regarding load transfer in the third load transfer member of FIG. 15;

FIG. 17 is a view illustrating a structure of a cooling passage installed in a cooking device according to an embodiment;

FIG. 18 is a view illustrating an example in which a cooling passage is disposed on a front surface of a cooking device according to an embodiment;

FIG. 19 is a view illustrating an example in which a cooling passage is disposed on a rear surface of a cooking device according to an embodiment;

FIG. 20 is a block diagram illustrating a configuration of a cooking device according to an embodiment; and

FIG. 21 is a flowchart illustrating controlling driving of a cooling fan in a cooking device according to an embodiment.

### MODE FOR CARRYING OUT THE INVENTION

Hereinafter, the present invention is described in detail with reference to the accompanying drawings. In the following description, specific details, such as detailed configurations and components, will be provided merely for a better understanding of embodiments of the disclosure. Accordingly, it should be apparent to one of ordinary skill in the art that various changes and modifications may be made to the embodiments described herein without departing from the scope and spirit of the disclosure. Further, no description is made of well-known functions and configurations for clarity and brevity.

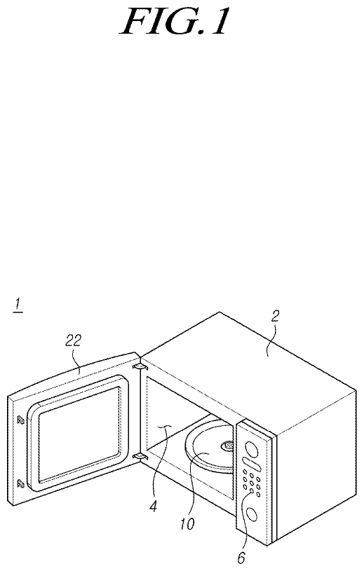

FIG. 1 is a perspective view illustrating a cooking device 1 according to various embodiments.

Referring to FIG. 1, a cooking device 1 may include a housing 2 forming an outer appearance, a cavity 4 provided inside the housing 2 to receive a cooking target (hereinafter, referred to as a “cooking ingredient”), a front panel 6 disposed on a front surface of the housing 2 and including a plurality of control buttons for controlling the cooking device 1, a tray assembly 10 disposed on a bottom of the cavity 4 to rotate the placed cooking ingredient or measure a load generated thereby, or a door assembly 22 disposed on the front surface of the housing 2 to open/close the cavity 4.

The cooking device may be an electronic device that may cook the cooking ingredient using at least one of high frequency waves, e.g., microwaves, radiant heat, or hot air. According to an embodiment, the cooking device 1 may support at least one operation mode among a microwave mode, an oven mode, or an air fryer mode. Although not shown, a component, such as a microwave generator for radiating microwaves, a grill heater for radiating radiant heat, or a convection heater for generating hot air, may be disposed on at least one of inner surfaces of the cavity 4. A temperature sensor for sensing the internal temperature of the cavity 4 may be provided on the inner rear surface of the cavity 4. The cavity 4 may be surrounded by an insulator (not shown) to insulate the cavity 4 from the outside.

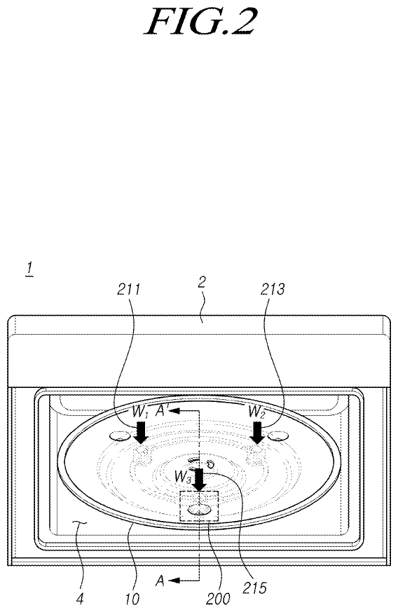

FIG. 2 is a view illustrating an example of a tray assembly (e.g., the tray assembly 10 of FIG. 1) in a cooking device (e.g., the cooking device 1 of FIG. 1) according to various embodiments.

Referring to FIG. 2, the tray assembly 10 disposed inside the housing 2 of the cooking device 1 may include a tray, a plurality of rollers, a rotating member, or a load measuring member. The rotating member may be disposed on a lower surface of the tray to help the tray rotate. The rotating member may include, e.g., a guide roller member connecting the plurality of rollers in a ring shape so that the plurality of rollers may rotate along a predetermined concentric circle. The load measuring member may measure loads (W₁, W₂, and W₃) 211, 213, and 215 due to the cooking ingredient placed on the tray, on the lower surface of the tray. The load measuring member may have a structure that transfers, e.g., loads (W₁, W₂, and W₃) 211, 213, and 215 due to the cooking ingredient placed on the tray in a vertical direction and generates an electrical signal by the loads (W₁, W₂, and W₃) 211, 213, and 215 transferred in the vertical direction. The electrical signal may be used to measure the weight of the cooking ingredient placed on the tray. The electrical signal may be, e.g., a sensing signal that senses the intensity of pressure.

According to an embodiment, the plurality of rollers and the rotating member for helping the tray rotate may be disposed between the tray and the bottom of the cavity (e.g., the cavity 4 of FIG. 1). The load measuring member may be disposed outside the cavity 4. For example, the load measuring member disposed under the bottom surface of the cavity 4 may pass through the bottom surface of the cavity 4 and may be vertically connected to the lower end portion of the rotating member in which the plurality of rollers are received.

According to an embodiment, the load measuring member for transferring the load due to the cooking ingredient placed on the tray to a load cell (not shown) may be provided for each of the rollers in rolling contact with the tray. For example, first to third load measuring members may be provided for the first to third rollers, respectively. The first load measuring member may transfer the first load (W₁) 211 transferred through the first roller to the load cell, the second load measuring member may transfer the second load (W₂) 213 transferred through the second roller to the load cell, and the third load measuring member 200 may transfer the third load (W₃) 215 transferred through the third roller to the load cell.

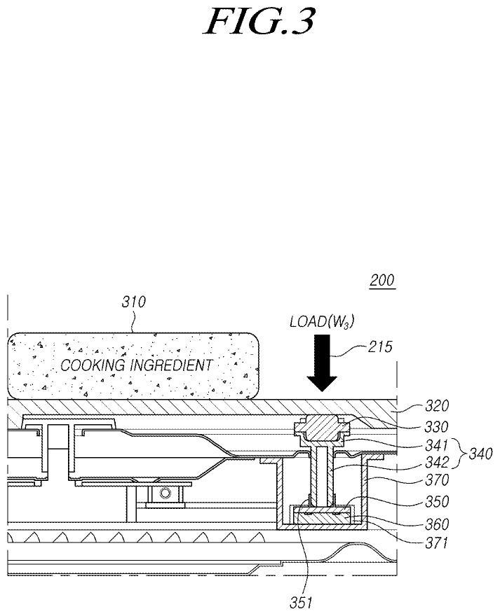

FIG. 3 is a cross-sectional view taken along A-A′ of the third load measuring member 200 of FIG. 2.

Referring to FIG. 3, the third load measuring member 200 according to an embodiment may have a structure in which the guide roller member 340, the load transfer member 350, the load cell 360, or the bracket 370 are physically coupled such that the load (W₃) 215 is transferred in the vertical direction. The guide roller member 340 may include a receiving tray 341 or a guide rod 342. The receiving tray 341 may have a housing shape surrounding the third roller 330 to receive that the third roller 330. The receiving tray 341 may be configured to surround a lower portion of the third roller 330 to stably support the third roller 330. The guide rod 342 may have a rod shape extending in the vertical direction from the lower surface of the receiving tray 341. The lower end portion of the guide rod 342 may be inserted into and fixed to the load transfer member 350. The load cell 360 may be disposed to contact the lower surface of the load transfer member 350. The bracket 370 may receive and protect the whole or part of the load transfer member 350 and the load cell 360.

According to an embodiment, the load (W₃) 215 applied to the third roller 330 due to the cooking ingredient 310 placed on the tray 320 may be transferred to the third load measuring member 200. The load (W₃) 215 may be transferred in the vertical direction through, e.g., the guide roller member 340 and the load transfer member 350 in which the third roller 330 is stored in the receiving tray 341. The load (W₃) 215 transferred in the vertical direction through the guide roller member 340 and the load transfer member 350 may be provided to the load cell 360 to be used to generate an electrical signal for measuring the weight of the cooking ingredient 310.

According to an embodiment, the rotating member included in the guide roller member 340 for helping the third roller 330 and the tray 320 rotate may be disposed inside the cavity (e.g., the cavity 4 of FIG. 1), i.e., on the bottom surface of the cavity, and the load transfer member 350 and the load cell 360 may be disposed outside the cavity, i.e., under the bottom surface of the cavity. The guide rod 342 included in the guide roller member 340 may be disposed to penetrate the bottom of the cavity. A hole due to a hollow structure may be formed inside the guide rod 342.

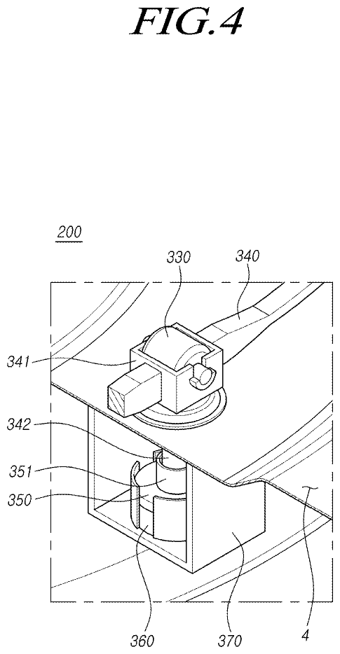

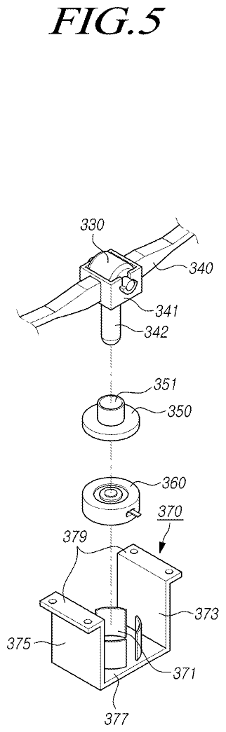

FIG. 4 is a perspective view of the third load measuring member 200 of FIG. 3, and FIG. 5 is an exploded perspective view of the third load measuring member 200 of FIG. 3.

Referring to FIGS. 4 and 5, the third load measuring member 200 may have a structure in which the roller 330, the guide roller member 340, the load transfer member 350, and the load cell 360 are sequentially coupled downward on the vertical axis. The upper portion of the roller 330 may be in rolling contact with the lower surface of the tray (e.g., the tray 320 of FIG. 3), and the lower portion of the roller 330 may be stably received in the receiving tray 341, which is the roller receiving housing provided in the guide roller member 340.

According to an embodiment, the guide roller member 340 may include a receiving tray 341 provided to allow the roller 330 in rolling contact to be independently mounted in the receiving tray 341 so as to be in contact with the bottom surface of the tray, and the guide rod 342 extending from the lower side of the receiving tray 341 in the vertical direction toward the bottom of the cavity (e.g., the cavity 4 of FIG. 1). The guide rod 342 may have a rod shape having a specific shape, such as a circular shape or a rectangular shape.

According to an embodiment, the load transfer member may have a first coupling portion 351 formed on an upper surface of a plate (e.g., a disk) to have an upper opening and a predetermined depth. The lower end portion of the guide rod 342 constituting the guide roller member 340 may be fitted and fixed to the first coupling portion 351. The inner shape of the first coupling portion 351 may be determined considering, e.g., the shape of the guide rod 342. For example, when the guide rod 342 has a cylindrical shape, it may be preferable that the inner shape of the first coupling portion 351 also has a circular shape.

According to an embodiment, the first coupling portion 351 may have a shape of a cylindrical structure extending in the vertical direction from the lower surface of the load transfer member 350. The lower portion of the cylindrical structure may be blocked by the lower surface of the load transfer member 350, and the upper portion of the cylindrical structure may be opened so that the lower end portion of the guide rod 342 may be inserted. The first coupling portion 351 may be deformed into a structure having a shape other than a cylindrical structure according to the shape of the lower end portion of the guide rod 342. For example, when the shape of the lower end portion of the guide rod 342 is rectangular, the first coupling portion 351 may be a rectangular structure.

According to an embodiment, the first coupling portion 351 may have a shape in which a plurality of partitions are disposed to surround the outer surface of the lower end portion of the guide rod 342. The plurality of partitions may be disposed to be spaced apart from each other at a predetermined interval. The partitions may have, e.g., the same width and/or height and may have an equal separation distance, but are not limited thereto. The partitions may have different widths and/or heights or unequal separation distances.

According to an embodiment, the inner space of the first coupling portion 351 may be determined considering the surface area of the portion to be inserted in the guide rod 342. In other words, the length from the lower portion to the upper portion of the first coupling portion 351, i.e., the depth of the first coupling portion 351 may be determined considering the height of the portion to be inserted in the guide rod 342, and the horizontal area of the first coupling portion 351 may be determined considering the cross-sectional area of the portion to be inserted in the guide rod 342. For example, when the first coupling portion 351 is a cylindrical structure, the height and diameter of the first coupling portion 351 may be determined considering the height of the guide rod 342 to be inserted into the first coupling portion 351 and the diameter or radius of the cross section of the guide rod 342.

According to an embodiment, the receiving tray 341 constituting the guide roller member 340 may be positioned above the bottom surface of the cavity 4, i.e., inside the cavity 4, and the load transfer member 350 and the load cell 360 may be positioned under the bottom surface of the cavity 4, i.e., outside the cavity 4. The guide rod 342 extending downward from the receiving tray 341 in the guide roller member 340 may penetrate the bottom of the cavity 4 and may be inserted into the first coupling portion 351 provided in the load transfer member 350.

According to an embodiment, the bracket 370 may be an injection-molded article including at least two vertical surfaces 373 and 375 and one horizontal surface 377. A fastening portion 379 for physical fastening with the lower surface of the cavity 4 may be provided at one end of each of the at least two vertical surfaces 373 and 375 constituting the bracket 370. The fastening portion 379 may be provided with one or more holes into which screws may be inserted from the bottom to the top for physical coupling with the lower surface of the cavity 4. The horizontal surface 377 constituting the bracket 370 may form the bottom of the bracket 370 by horizontally connecting the other ends of the at least two vertical surfaces 373 and 375. The horizontal surface 377 constituting the bracket 370 may have a second coupling portion 371 with an upper opening and a predetermined depth to allow, e.g., the plate constituting the load transfer member 350 and the load cell 360 to be inserted thereinto.

According to an embodiment, the second coupling portion 371 may have a shape of a cylindrical structure extending in the vertical direction from the horizontal surface 377 provided in the bracket 370. The lower portion of the cylindrical structure may be blocked by the horizontal surface of the bracket 370, and the upper portion of the cylindrical structure may be opened so that the lower plate constituting the load transfer member 350 and/or the load cell 360 may be inserted. The second coupling portion 371 may be deformed into a structure having a shape other than a cylindrical structure according to the shape of the lower plate constituting the load transfer member 350 and/or the shape of the load cell 360. For example, when the shape of the lower plate constituting the load transfer member 350 and/or the shape of the load cell 360 are rectangular, the second coupling portion 371 may be a rectangular structure.

According to an embodiment, the second coupling portion 371 may have a shape in which a plurality of partitions are disposed to surround the outer surfaces of the lower plate constituting the load transfer member 350 and/or the load cell 360. The plurality of partitions may be disposed to be spaced apart from each other at a predetermined interval. The partitions may have, e.g., the same width and/or height and may have an equal separation distance, but are not limited thereto. The partitions may have different widths and/or heights or unequal separation distances.

According to an embodiment, the internal space of the second coupling portion 371 may be determined considering the surface area of the portion to be inserted in the load transfer member 350 and the surface area of the load cell 360. In other words, the length from the lower portion to the upper portion of the second coupling portion 371, i.e., the depth of the second coupling portion 371 may be determined considering the height of the portion to be inserted in the load transfer member 350 and the height of the load cell 360, and the horizontal area of the second coupling portion 371 may be determined considering the cross-sectional area of the portion to be inserted in the load transfer member 350 and/or the cross-sectional area of the load cell 360. For example, when the second coupling portion 371 is a cylindrical structure, the height and diameter of the second coupling portion 371 may be determined considering the height of a portion of the load transfer member 350 to be inserted into the second coupling portion 371 and the height of the entire load cell 360 and the diameter or radius of the cross section of the portion of the load transfer member 350 and/or the load cell 360.

According to an embodiment, an elastic member may be disposed between the lower end portion of the guide rod 342 included in the guide roller member 340 and the bottom surface of the first coupling portion 351 provided in the load transfer member 350. One side of the elastic member may be coupled to the lower end portion of the guide rod 342, and the other side of the elastic member may be fitted and coupled to the first coupling portion 351. The elastic member may be, e.g., a coil spring.

According to an embodiment, the guide rod 342 included in the guide roller member 340 may have a hollow structure with a hollow hole in the longitudinal direction. The hole present inside the guide rod 342 may have a lower opening. An upper end portion of the elastic member may be fitted into the lower opening of the guide rod 342. The lower end portion of the elastic member may be fitted to the first coupling portion 351 provided in the load transfer member 350. The elastic member may be, e.g., a coil spring.

In FIGS. 2 to 5 described above, the plurality of rollers 330 in rolling contact with the lower surface of the tray 320 are illustrated as having a wheel shape similar to a lying circular column, but may be implemented in any shape capable of rolling contact with the lower surface of the tray 320. For example, the plurality of rollers 330 may have a ball shape rather than a wheel shape. When the plurality of rollers 330 have a ball shape rather than a wheel shape, a contact surface with the tray 320 may be minimized. When the contact surface with the tray 320 is minimized, noise due to rotation may be reduced. However, when the plurality of rollers 330 are configured in a ball shape, a receiving tray structure may be required to allow the ball-shaped rollers to be mounted independently and stably in the guide roller member 340. For example, the receiving tray included in the guide roller member 340 may be configured in a semicircular shape with an upper opening to receive the ball-shaped rollers.

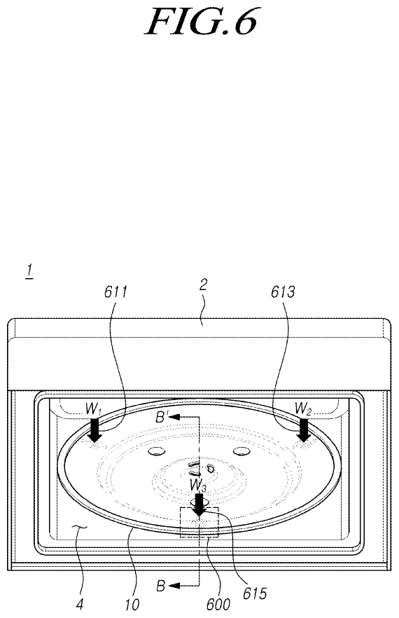

FIG. 6 is a view illustrating another example of a tray assembly (e.g., the tray assembly 10 of FIG. 1) in a cooking device (e.g., the cooking device 1 of FIG. 1) according to various embodiments.

In FIG. 6, unlike the structure of the tray assembly 10 illustrated in FIG. 2, a structure of a tray assembly 10 in which a plurality of rollers are disposed between a tray and a bottom of a cavity (e.g., the cavity 4 of FIG. 1) is proposed. In other words, only the upper end portions of the plurality of rollers among the components included in the tray assembly 10 may be exposed inside the cavity 4, i.e., above the bottom surface of the cavity 4, and the remaining components may be hidden under the bottom surface of the cavity 4.

According to an embodiment, the load measuring member for transferring the load due to the cooking ingredient placed on the tray to a load cell (not shown) may be provided for each of the rollers in rolling contact with the tray. For example, first to third load measuring members may be provided for the first to third rollers, respectively. The first load measuring member may transfer the first load (W₁) 611 transferred through the first roller to the load cell, the second load measuring member may transfer the second load (W₂) 613 transferred through the second roller to the load cell, and the third load measuring member 600 may transfer the third load (W₃) 615 transferred through the third roller to the load cell.

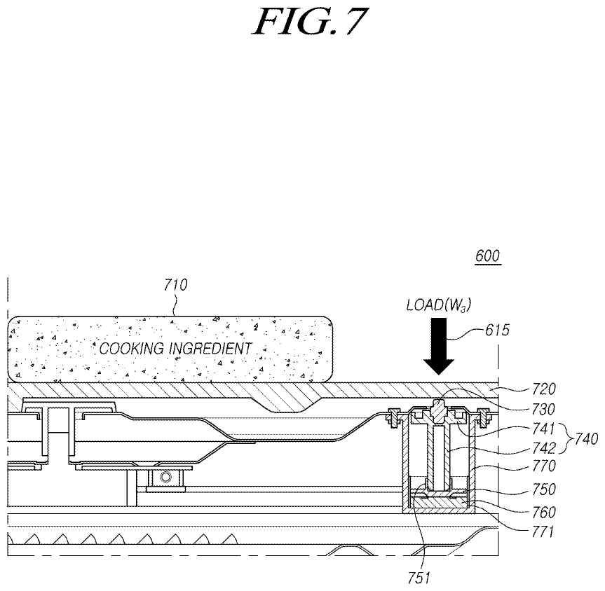

FIG. 7 is a cross-sectional view taken along B-B′ of the third load measuring member 600 of FIG. 6.

Referring to FIG. 7, the third load measuring member 600 according to an embodiment may have a structure in which the guide roller member 740, the load transfer member 750, the load cell 760, or the bracket 770 are physically coupled such that the load (W₃) 615 is transferred in the vertical direction. The guide roller member 740 may include a receiving tray 741 or a guide rod 742. The receiving tray 741 may have a housing shape surrounding the third roller 720 to receive that the third roller 330. The receiving tray 341 may be configured to surround a lower portion of the third roller 330 to stably support the third roller 330. The guide rod 342 may have a rod shape extending in the vertical direction from the lower surface of the receiving tray 341. The lower end portion of the guide rod 742 may be inserted into and fixed to the load transfer member 750. The load cell 760 may be disposed to contact the lower surface of the load transfer member 750. The bracket 370 may receive and protect the whole or part of the load transfer member 750 and the load cell 760.

According to an embodiment, the load (W₃) 615 applied to the third roller 730 due to the cooking ingredient 710 placed on the tray 720 may be transferred to the third load measuring member 600. The load (W₃) 615 may be transferred in the vertical direction through, e.g., the guide roller member 740 and the load transfer member 750 in which the third roller 730 is stored in the receiving tray 741. The load (W₃) 615 transferred in the vertical direction through the guide roller member 740 and the load transfer member 750 may be provided to the load cell 760 to be used to generate an electrical signal for measuring the weight of the cooking ingredient 710.

According to an embodiment, the lower end portion of the third roller 730 stored in the receiving tray 741 constituting the guide roller member 740 may be disposed outside the cavity 4 (e.g., the cavity 4 of FIG. 1), i.e., under the bottom surface of the cavity 4, and the upper end portion of the third roller 730 not stored in the receiving tray 741 may be disposed inside the cavity 4, i.e., above the bottom surface of the cavity 4.

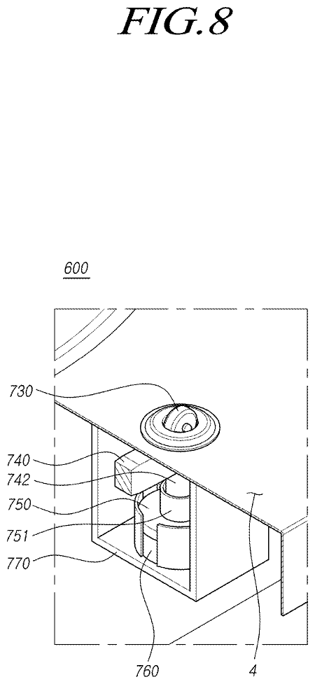

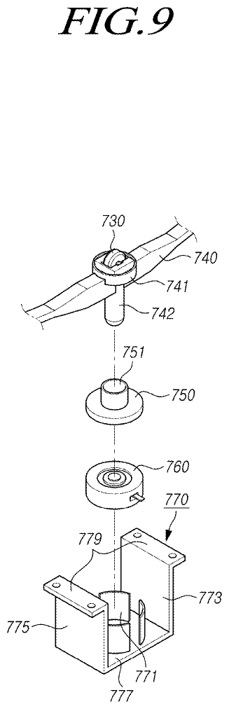

FIG. 8 is a perspective view of the third load measuring member 600 of FIG. 6, and FIG. 9 is an exploded perspective view of the third load measuring member 600 of FIG. 6.

In FIGS. 8 and 9, unlike the structure illustrated in FIGS. 4 and 5, proposed is a structure in which only the upper end portion of the third roller 730 (e.g., the third roller 730 of FIG. 7) is disposed between the tray (e.g., the tray 320 of FIG. 3) and the bottom of the cavity 4 (e.g., the cavity 4 of FIG. 1). In other words, only the upper end portion of the third roller 730 among the components included in the third load measuring member 600 may be exposed inside the cavity 4, and the remaining components may be hidden under the bottom surface of the cavity 4. The components of the third load measuring member 600 hidden under the bottom surface of the cavity 4 may include the lower end portion of the third roller 730, the guide roller member 740, the load transfer member 750, the load cell 760, and the bracket 760. Although not shown, the lower end portion of the third roller 730 may be stably received in the receiving tray which is the roller receiving housing provided in the guide roller member 740.

Among all the components illustrated in FIGS. 8 and 9, the third roller 730 and the remaining components other than the receiving tray 741 for receiving the third roller 730 in the guide roller member 740, i.e., the guide rod 742 constituting the guide roller member 740, the load transfer member 750 having the first coupling portion 751, the load cell 760, and the bracket 770 having the second coupling portion 771 may have the same structure and function as the corresponding components in FIGS. 3 to 5. For this reason, a detailed description of the remaining components illustrated in FIGS. 8 and 9 will be omitted.

According to an embodiment, in FIGS. 6 to 9, an elastic member may be disposed between the lower end portion of the guide rod 742 included in the guide roller member 740 and the bottom surface of the first coupling portion 751 provided in the load transfer member 750. Further, in FIGS. 6 to 9, a ball-shaped roller may be applied instead of the wheel-shaped roller 730 provided to be in rolling contact with the lower surface of the tray 320. This has already been described with reference to FIGS. 2 to 5, and thus a detailed description thereof will be omitted.

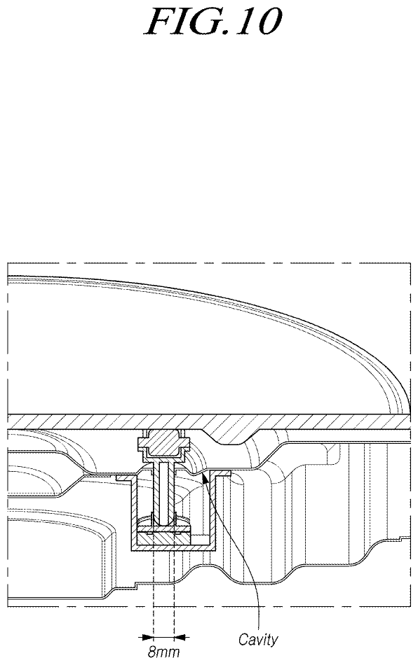

FIG. 10 is a view illustrating an example design of a guide roller member (e.g., the guide roller member 340 of FIGS. 3 to 5) in a cooking device (e.g., the cooking device 1 of FIG. 1) according to an embodiment.

Referring to FIG. 10, in the guide roller member 340 according to an embodiment, the guide rod 342 may have a hole having a size smaller than the wavelength A of the electromagnetic wave to prevent the electromagnetic wave corresponding to the microwave from leaking. For example, since the wavelength of the electromagnetic wave used in the microwave mode in the cooking device 1 is about 12 centimeters (cm) (2450 MHZ), the size of the inner hole in the guide rod 342 may be 8 to 9 millimeters (mm). In this case, electromagnetic waves generated inside a cavity (e.g., the cavity 4 of FIG. 1) may be prevented from leaking to the outside through the guide roller member 340 that may be installed through the lower surface of the cavity 4.

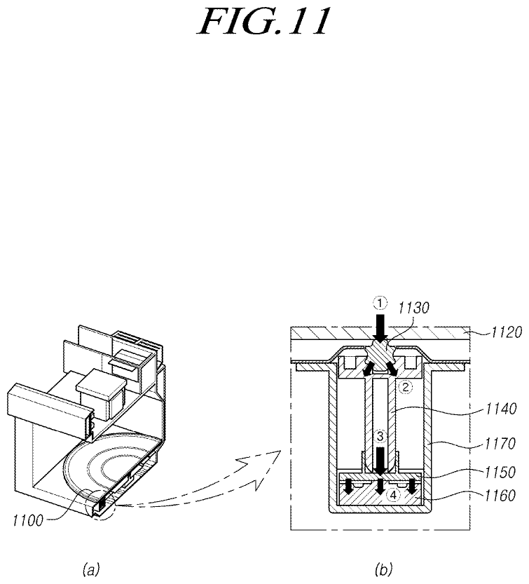

FIG. 11(a) is a cross-sectional view illustrating a cavity (e.g., the cavity 4 of FIG. 1) in a cooking device (e.g., the cooking device 1 of FIG. 1) and FIG. 11(b) is a view illustrating an example in which a load due to a cooking ingredient (e.g., the cooking ingredient 310 of FIG. 3 or the cooking ingredient 710 of FIG. 7) placed on a tray 1120 is transferred to a load cell 1160 (e.g., the load cell 360 of FIG. 3 to 5 or the load cell 760 of FIGS. 7 to 9) according to various embodiments.

Referring to FIG. 11, (a) illustrates an example of placement of a load transfer assembly 1100 transferring the load due to the cooking ingredient 310 or 710 placed on the tray 1120 of the cooking device 1 in the vertical direction, i.e., toward the load cell 1160.

According to an embodiment, in (b), the load \textcircled{1} due to the cooking ingredient 310 or 710 placed on the tray 1120 of the cooking device 1 may be transferred to the guide rod (e.g., the guide rod 342 of FIGS. 3 to 5) of the guide roller member (e.g., the guide roller member 340 of FIGS. 3 to 5) which is the vertical direction, through the roller 1130 (e.g., the roller 360 of FIGS. 3 to 5 or the roller 730 of FIGS. 7 to 9) (\textcircled{2}. The load \textcircled{2} transferred to the guide rod 1140 may act as a load \textcircled{3} applied to the load transfer member 1150 which is the vertical direction. The load \textcircled{3} applied to the load transfer member 1150 may be transferred to the load cell 1160 which is the vertical direction \textcircled{4}). The load cell 1160 may generate an electrical signal corresponding to the pressure caused by the load \textcircled{4} transferred in the vertical direction from the load transfer member 1150. The electrical signal may be used to measure the weight of the cooking ingredient 310 or 710.

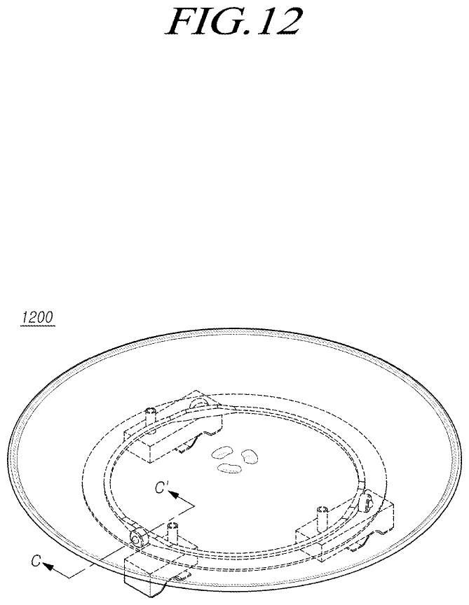

FIG. 12 is a view illustrating another example of a tray assembly 1200 (e.g., the tray assembly 10 of FIG. 1) in a cooking device (e.g., the cooking device 1 of FIG. 1) according to various embodiments.

Referring to FIG. 12, a tray assembly 1200 according to an embodiment may include a tray (e.g., the tray 320 of FIG. 3 or the tray 720 of FIG. 7), a plurality of rollers, a rotating member disposed on a lower surface of the tray to help the tray rotate, or a load measuring member measuring the load due to a cooking ingredient placed on the tray on the lower surface of the tray. The rotating member may include, e.g., a guide roller member connecting the plurality of rollers in a ring shape so that the plurality of rollers may rotate along a predetermined concentric circle. The load measuring member may have a structure that transmits, e.g., the load due to the cooking ingredient placed on the tray in a vertical direction and generates an electrical signal for measuring the weight of the cooking ingredient by the load transferred in the vertical direction.

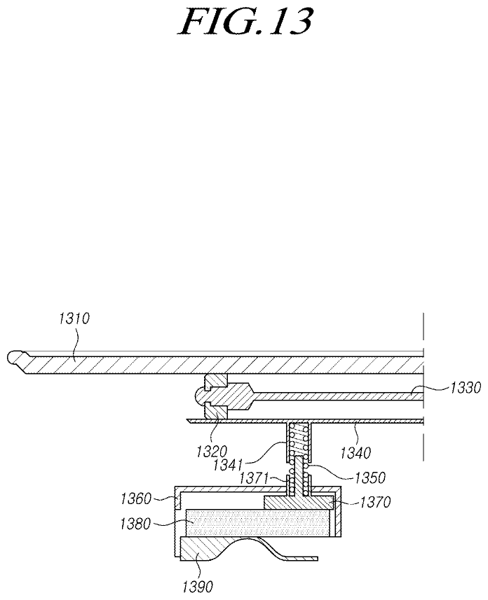

FIG. 13 is a cross-sectional view taken along C-C′ in the tray assembly shown in FIG. 12.

Referring to FIG. 13, according to an embodiment, the tray assembly having a structure for transferring the load in the vertical direction may include a tray 1310, a roller 1320, a roller guide 1330, a support plate 1340, an elastic member 1350, a sensor housing 1360, a guide injection-molded article 1370, a load cell 1380, or a load cell fixing member 1390.

According to an embodiment, the roller 1320 may be in rolling contact between the rear surface of the tray 1310 and the support plate 1340. The roller 1320 may be horizontally connected to a rotation shaft (not shown) disposed in a central portion of the tray 1310 by the roller guide 1330 and may be guided to rotate along a predetermined concentric circle.

According to an embodiment, a pipe-shaped upper elastic member insertion portion 1341 having a lower opening and a predetermined depth in the vertical axis may be provided on the lower surface of the support plate 1340 disposed to face the tray 1310 to allow the upper portion of the elastic member 1350 to be inserted thereinto.

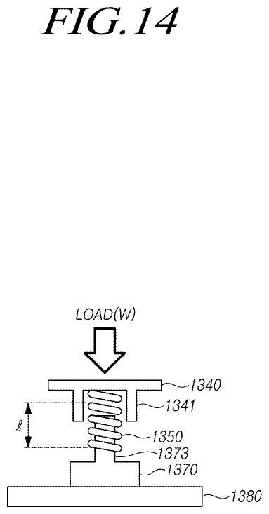

According to an embodiment, a pipe-shaped lower elastic member insertion portion 1371 having an upper opening and a predetermined depth in the vertical axis may be provided on the upper surface of the guide injection-molded article 1370 to allow the lower portion of the elastic member 1350 to be inserted thereinto. A protruding coupling portion (e.g., the protruding coupling portion 1373 of FIG. 14) extending upward along the vertical axis from an inner bottom surface of the lower elastic member insertion portion 1371 in a rod shape may be provided on the upper surface of the guide injection-molded article 1370. The lower portion of the elastic member 1350 may be fitted over the protruding coupling portion 1373 provided in the guide injection-molded article 1370 downward along the vertical axis and be inserted into the lower elastic member insertion portion 1371. The upper portion of the elastic member 1350 may be inserted into the upper elastic member insertion portion 1341 provided on the support plate 1340 upward along the vertical axis. In this case, the elastic member 1350 may be disposed between the support plate 1340 and the guide injection-molded article 1370 to transfer the load due to the cooking ingredient placed on the tray 1310 transferred through the support plate 1340 to the guide injection-molded article 1370.

According to an embodiment, the load cell 1380 may face the upper surface, and the lower surface of the guide injection-molded article 1370 may contact it. The load cell 1380 may generate an electrical signal by a pressure corresponding to a load transferred in the vertical direction from the guide injection-molded article 1370. The electrical signal may be a sensing signal that senses the intensity of the pressure. A load cell fixing member 1390 may be disposed on a lower surface of the load cell 1380. The load cell 1380 may be supported to be fixed to the bottom by the load cell fixing member 1390. The guide injection-molded article 1370 and the load cell 1380 may be packaged and protected by the sensor housing 1360. In this case, the lower elastic member insertion portion and the protruding coupling portion provided upward along the vertical axis in the guide injection-molded article 1370 may be formed through the upper surface of the sensor housing 1360.

In the above-described structure of the tray assembly, the elastic member 1350 provided between the support plate 1340 and the guide injection-molded article 1370 may be a coil spring. When the coil spring is used as the elastic member 1350, it is possible to secure a relatively large free field compared to the leaf spring, thereby stably ensuring the reliability of the load sensing value that may be lowered due to the assembly tolerance of the cooking device 1.

FIG. 14 is a view illustrating a structure of a load transfer assembly (e.g., the load transfer assembly 1100) in a tray assembly (e.g., the tray assembly 10 of FIG. 1) of a cooking device (e.g., the cooking device 1 of FIG. 1) according to an embodiment.

Referring to FIG. 14, a load transfer assembly according to an embodiment may have a structure in which a lower surface of the guide injection-molded article 1370 is placed in contact on an upper surface of the load cell 1380, a passage provided in a lower portion of the coil spring 1350 is fitted into the protruding coupling portion 1373 provided upward along the vertical axis in the guide injection-molded article 1370, and an upper portion of the coil spring 1350 is inserted into the upper elastic member insertion portion 1341 provided downward along the vertical axis in the support plate 1340. For the coil spring 1340 fixed by the support plate 1340 and the guide injection-molded article 1370, a free field may be guaranteed by a gap l.

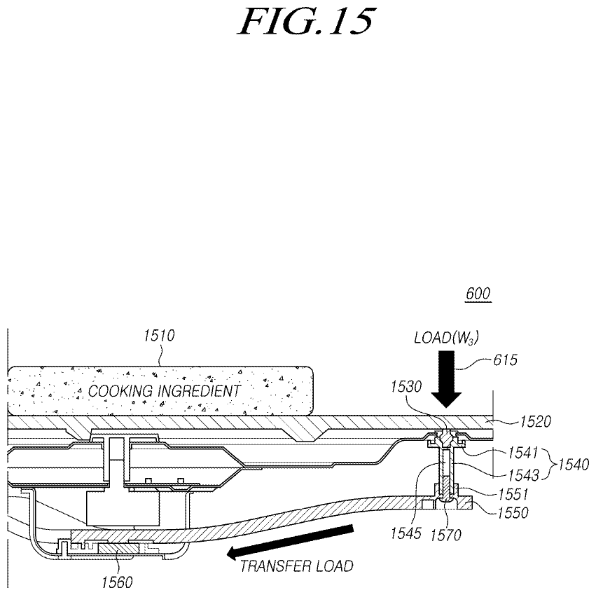

FIG. 15 is another cross-sectional view taken along B-B′ for the third load measuring member of FIG. 6 (e.g., the load measuring member 600 of FIG. 6).

Referring to FIG. 15, a third load measuring member 600 according to an embodiment may include a guide roller member 1540 in which a third roller 1530 is stored, a load transfer member 1550 having one side end coupled to the guide roller member 1540, a load cell 1560 disposed in contact with another side end of the load transfer member 1550 under a substantial center of a tray 1520, or a bracket fastened by a coupling member, such as a screw, to a lower surface of a cavity to receive and protect a portion of the load transfer member 1550, the load cell 1560, and a motor for rotating the tray 1520.

According to an embodiment, the guide roller member 1540 may include a receiving tray 1541 provided to allow the roller 1520 to be independently mounted in the receiving tray 1541 so as to be in contact with the bottom surface of the tray, and the guide rod 1543 extending from the lower side of the receiving tray 1541 in the vertical direction toward the bottom of the cavity (e.g., the cavity 4 of FIG. 1). The guide rod 1543 may have, e.g., a rod shape. The guide rod 1543 may have a hollow structure in which a hollow hole 1545 is present in the longitudinal direction in the central portion.

According to an embodiment, the load transfer member 1550 may have, at one side end thereof, a coupling portion 1551 into which a lower end portion of the guide rod 1543 included in the guide roller member 1540 may be fitted. The coupling portion 1551 may have a hole penetrating the bottom surface downward. The upper surface of the hole formed in the bottom surface of the coupling portion 1551 may be disposed to face the lower surface of the hole 1545 formed in the longitudinal direction in the central portion of the guide rod 1543 when the lower end portion of the guide rod 1543 is fitted. A bolt 1570 inserted upward from the bottom of the hole formed in the bottom of the coupling portion 1551 may reach the hole 1545 formed in the lower end portion of the guide rod 1543. In this case, the load transfer member 1550 may be stably fixed to the guide roller member 1540 by the bolt 1570.

According to an embodiment, the load (W₃) 615 at the third roller 1530 due to the cooking ingredient 1510 placed on the tray 1520 may be transferred to the third load measuring member 600. The load (W₃) 615 may be transferred in the vertical direction through, e.g., the guide roller member 1540 in which the third roller 1530 is stored. The load transferred through the guide roller member 1540 may be transferred to the load cell 1560 in a substantially horizontal direction through the load transfer member 1550. The load (W₃) 615 transferred in the substantially horizontal direction through the load transfer member 1550 after being transferred in the vertical direction through the guide roller member 1540 may be provided to the load cell 1560 to be used to generate an electrical signal for measuring the weight of the cooking ingredient 1510.

According to an embodiment, in FIG. 15, a ball-shaped roller may be applied instead of the wheel-shaped roller 1530 provided to be in rolling contact with the lower surface of the tray 1520. Since the ball-shaped roller has been described in the description of FIGS. 2 to 5, no detailed description thereof is given.

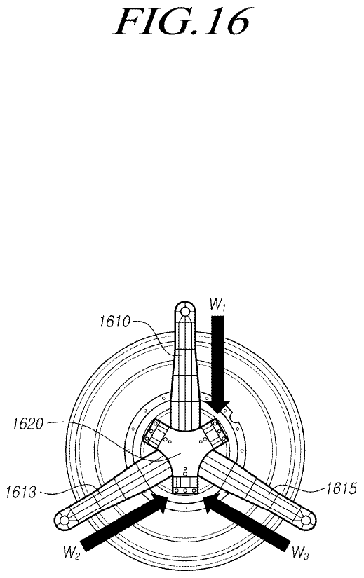

FIG. 16 is a view illustrating an example of transferring load by the third load transfer member of FIG. 15 (e.g., the load measuring member 600 of FIG. 6).

Referring to FIG. 16, the three load transfer members 1611, 1613, and 1615 may be coupled to a guide roller member (e.g., the guide roller member 1540 of FIG. 15) receiving the corresponding rollers and may be disposed to transfer loads W₁, W₂, and W₃ (e.g., the loads (W₁, W₂, and W₃) 211, 213, and 215 of FIG. 2) due to the cooking ingredient placed on the tray. In the load transfer members 1611, 1613, and 1615 provided to correspond to the plurality of rollers, respectively, for example, first side ends of the two opposite side ends may be gathered substantially in the center direction, and second side ends may be coupled to the guide roller member. The first side end portions of the load transfer members 1611, 1613, and 1615 gathered substantially near the center of the tray may be fitted and fixed to the coupling member 1620. The coupling member 1620 may be made, e.g., by injection molding inside a bracket (e.g., the bracket of FIG. 15) covering a load cell (e.g., the load cell 1560 of FIG. 15). The loads transferred by the load transfer members 1611, 1613, and 1615 fixed by the coupling member 1620 may be provided to the load cell positioned in the coupling member 1620.

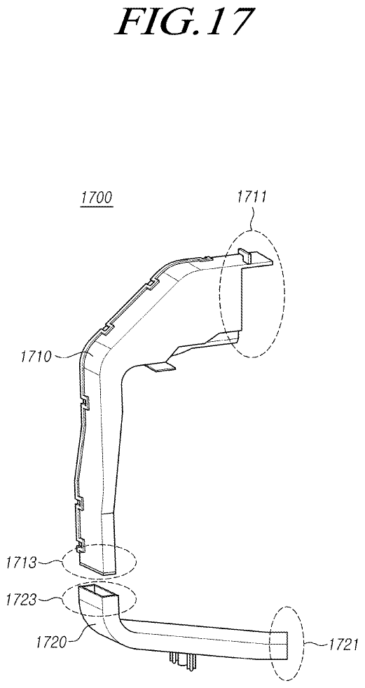

FIG. 17 is a view illustrating a structure of a cooling passage 1700 installed in a cooking device (e.g., the cooking device 1 of FIG. 1) according to an embodiment.

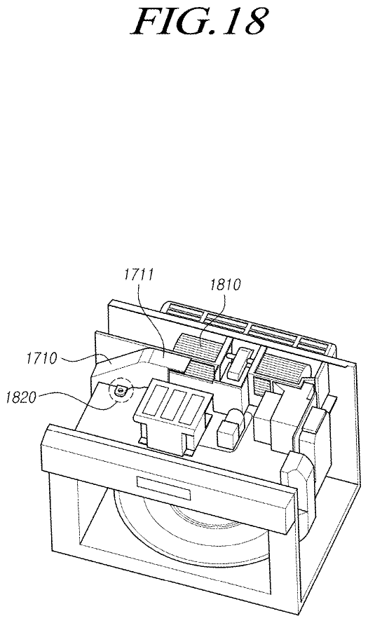

Referring to FIG. 17, a cooling passage 1700 according to an embodiment may be an assembly of a cooling passage upper member 1710 and a cooling passage lower member 1720. The cooling passage 1700 may be a passage for supplying cooling air made by a cooling fan (e.g., the cooling fan 1810 of FIG. 18) provided at an upper portion of the cooking device 1 to a lower portion of the cooking device 1 where one or more pressure sensors (e.g., the load cell 360 of FIGS. 3 to 5, the load cell 760 of FIGS. 7 to 9, the load cell 1380 of FIGS. 13 and 14, or the load cell 1560 of FIG. 15) are disposed. The cooling passage 1700 may be fixed to each of the lower base plate of the cooking device 1 and the upper cavity bracket using a fastening member, e.g., a screw.

According to an embodiment, the cooling passage 1700 may be divided into a plurality of pieces by assembly and/or assembly tolerance. The cooling passage 1700 may be assembled as another side 1713 of the upper passage 1710 where one side 1711 is coupled to the cooling fan 1810 is fitted into one side 1723 of the lower passage 1720 corresponding thereto. The other side 1721 of the lower passage 1720 may be disposed to face the lower end portion of the cooking device 1 where one or more pressure sensors are disposed so that the cooling air may be supplied to the position where the one or more pressure sensors are disposed.

FIG. 18 is a view illustrating an example in which a cooling passage (e.g., the cooling passage 1700 of FIG. 17) is disposed on a front surface of a cooking device (e.g., the cooking device 1 of FIG. 1) according to an embodiment.

Referring to FIG. 18, the upper end member 1710 of the cooling passage 1700 may be disposed such that one side 1711 is coupled to the cooling fan 1810 and extends from the upper surface of the cooking device 1 to the rear surface through the right surface. On the upper surface of the cooking device 1, the upper end member 1710 of the cooling passage 1700 may be coupled to a housing (e.g., the housing 2 of FIG. 1) by a fastening member such as a screw constituting the lower assembly portion 1820.

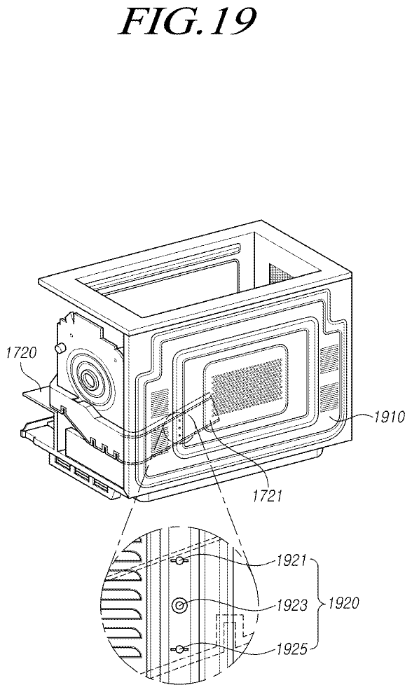

FIG. 19 is a view illustrating an example in which a cooling passage (e.g., the cooling passage 1700 of FIG. 17) is disposed on a rear surface of a cooking device (e.g., the cooking device 1 of FIG. 1) according to an embodiment.

Referring to FIG. 19, the lower end member 1720 of the cooling passage 1700 may be disposed to extend to the rear surface through the right surface of the cooking device 1. A base plate 1910 may be present on the rear surface of the cooking device 1. On the rear surface of the cooking device 1, the lower end member 1720 of the cooling passage 1710 may be covered by the base plate 1910 and then coupled by fastening members 1921, 1923, and 1925 such as screws constituting the lower end assembly part 1920. An end 1721 of the lower end member 1720 of the cooling passage 1700 may be disposed in a direction in which cooling air may be supplied to one or more pressure sensors provided inside the plate.

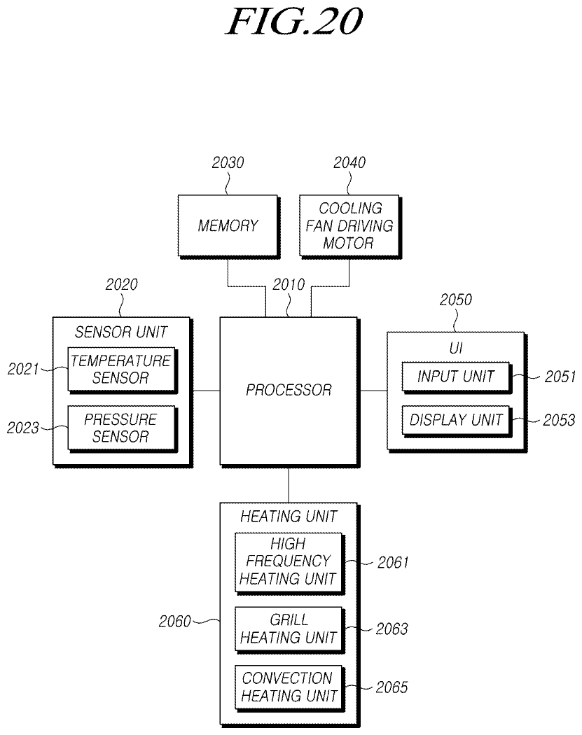

FIG. 20 is a block diagram illustrating a configuration of a cooking device (e.g., the cooking device 1 of FIG. 1) according to an embodiment.

Referring to FIG. 20, a cooking device 1 may include a processor 2010, a sensor unit 2020, memory 2030, a cooling fan driving motor 2040, a user interface (UI) 2050 (e.g., the front panel 6 of FIG. 1), or a heating unit 2060. The sensor unit 2020 may include a temperature sensor 2021 or one or more pressure sensors 2023 (e.g., the load cell 360 of FIGS. 3 to 5, the load cell 760 of FIGS. 7 to 9, the load cell 1380 of FIGS. 13 and 14, or the load cell 1560 of FIG. 15). The UI 2050 may include an input unit 2051 or a display unit 2053. The heating unit 2060 may include a high frequency heating unit 2061, a grill heating unit 2063, or a convection heating unit 2065.

The processor 2010 may control the overall operation according to the operation mode of the cooking device 1. The processor 2010 may support one or more operation modes among, e.g., a microwave mode, an oven mode, or an air fryer mode. The microwave mode may be an operation mode in which the cooking ingredient is cooked, heated, or warmed using high frequency waves such as microwaves. The microwave mode does not directly increase the internal temperature of the cavity during the cooking process, but the internal temperature of the cavity may increase due to an indirect cause such as an increase in the temperature of the cooking ingredient and/or the generation of steam. The oven mode or the air fryer mode may be an operation mode in which the cooking ingredient is cooked, heated, or warmed using radiant heat or hot air radiated by a heater. The oven mode or the air fryer mode may directly increase the internal temperature of the cavity during the cooking process.

According to an embodiment, the processor 2021 may perform control for turning on/off the cooling fan driving motor 2040 considering at least one of the set operation mode and/or the internal temperature of the cavity (e.g., the cavity 4 of FIG. 1). The cooling fan driving motor 2040 may provide power for turning a cooling fan (e.g., the cooling fan 1810 of FIG. 18). The cooling fan 1810 may supply external air to one or more pressure sensors 2023 (e.g., the load cell 360 of FIGS. 3, 4, and 5, the load cell 760 of FIGS. 7, 8, and 9, or the load cell 1560 of FIG. 15) disposed under the cavity, thereby preventing the pressure sensor from being damaged due to an increase in the internal temperature of the cavity. The processor 2010 may control the cooling fan 1810 to be driven, e.g., when cooking is performed in the oven mode or the air fryer mode or until the internal temperature of the cavity drops below the set threshold temperature even when cooking is completed. For example, when operating in the microwave mode, the processor 2010 may control the cooling fan 1810 to be driven until the internal temperature of the cavity rises above the set threshold temperature and then falls below the threshold temperature. For example, the processor 2010 may control the cooling fan 1810 to operate when cooking is performed in the operation mode (e.g., the oven mode or the air fryer mode) in which direct heat is applied or until the internal temperature of the cavity drops below the set temperature even when cooking is completed, or may control the cooling fan 1810 to operate only when the internal temperature of the cavity rises higher than the set temperature when operating in the operation mode (e.g., the microwave mode) in which no direct heat is applied.

According to an embodiment, the processor 2010 may heat the cooking ingredient by controlling the operation of the high frequency heating unit 2061, the grill heating unit 2063, or the convection heating unit 2065 according to the detection result of the temperature sensor 2021 and/or the user's operation command input through the input unit 2051. The processor 2010 may control the operation of the high frequency heating unit 2061 in the microwave mode, may control the operation of the grill heating unit 2063 in the oven mode, and may control the operation of the convection heating unit 2065 in the air fryer mode.

The input unit 2051 may output signals corresponding to various operation commands such as a cooking start, a cooking time, a cooking cancellation, or a pause by the user's manipulation. The input unit 2051 may be made in various forms such as a button-type switch, a membrane switch, and a dial. According to an embodiment, the input unit 2051 may include function selection buttons for selecting an operation mode according to a heating method, such as high frequency heating, grill heating, or convection heating, an up/down dial for inputting information such as the cooking time or the weight of the cooking ingredient, a cancel button for inputting a stop command of the cooking device 1, or a selection/start button for inputting a start command of the cooking device 1.

The display unit 2053 may display, to the user, operation statuses such as the output of the cooking device 1, operation mode, internal temperature, the weight of the cooking ingredient, or the cooking time. The display unit 2053 may be configured by employing a liquid crystal display (LCD) panel or a light emitting diode (LED) panel.

Although the input unit 2051 and the display unit 2053 included in the UI 2050 are separately provided in the cooking device 1 in the drawings, a touch screen panel (TSP) in which the input unit 2051 and the display unit 2053 are integrally provided may be employed.

The high frequency heating unit 2061 may be provided in the machine room on the right side of the cavity. The high frequency heating unit 2061 may include a magnetron (not shown) for generating high frequency waves such as microwaves radiated into the cavity, and a high voltage transformer (not shown) for applying a high voltage to the magnetron.

According to an embodiment, the high frequency heating unit 2061 may radiate a high frequency wave of 2.45 GHz to the inside of the cavity through the right wall surface of the inside of the cavity to heat the cooking ingredient positioned inside of the cavity. The high frequency wave radiated by the high frequency heating unit 2061 may pass through the cooking ingredient positioned in the cavity to heat the inside of the cooking ingredient. The high frequency heating unit 2061 may employ a fixed-power high frequency heating unit that outputs only the high frequency of the maximum output power. The fixed-power high frequency heating unit may radiate high frequency waves of various power levels through a ratio of the time for radiating high frequency waves to the time for not radiating high frequency waves. For example, when the maximum output is 900 W, the high frequency operation unit may repeatedly operate the high frequency heating unit for 20 seconds and stop the operation of the high frequency heating unit for 10 seconds to thereby radiate a high frequency wave of 600 W on average. The high frequency heating unit 2061 may adopt a variable output high frequency heating unit that directly radiates high frequency waves of various power levels by employing an inverter as the driving circuit.

The grill heating unit 2063 may be provided on an upper side of the cavity and may include a grill heater (not shown) for radiating radiant heat and a reflector (not shown) for concentrating the radiated radiant heat into the cavity. The grill heater may employ a halogen lamp that emits strong radiant heat, a heating wire that radiates Joule heat through electrical resistance, or the like. According to an embodiment, the grill heating unit 2063 is provided inside the upper wall surface of the cavity and includes a grill heater for radiating radiant heat. The radiant heat radiated by the grill heater may be directly radiated to the cooking ingredient provided in the cavity, or may be reflected on the upper inner wall of the cavity and then radiated to the cooking ingredient.

The convection heating unit 2065 may be provided outside a left wall surface of the cavity and may include a convection heater (not shown) for generating hot air for heating the cooking ingredient, a convection circulation fan (not shown) for supplying heated air around the convection heater into the inside of the cavity, and a convection driving motor (not shown) for providing a rotational force to the convection circulation fan 143. The convection heating unit 2065 may be provided outside a rear wall surface of the cavity and may include a convection heater (not shown) for generating hot air for heating the cooking ingredient, a convection circulation fan (not shown) for supplying heated air around the convection heater into the inside of the cavity, and a convection driving motor (not shown) for providing a rotational force to the convection circulation fan.

The temperature sensor 2021 may detect the internal temperature of the cavity and provide the detected internal temperature to the processor 2010. The temperature sensor 2021 may employ a thermistor in which the electrical resistance value changes according to temperature.

One or more pressure sensors 2023 may be disposed between a tray (e.g., the tray 320 of FIG. 3, the tray 720 of FIG. 7, the tray 1310 of FIG. 13, or the tray 1520 of FIG. 15) and the bottom surface of a cavity (e.g., the cavity 4 of FIG. 1). The structure in which the pressure sensor 2023 is disposed is as illustrated in FIG. 3 to 5, 7 to 9, 13 and 14, or 15. The pressure sensor 2023 may receive the load due to the cooking ingredient placed on the tray through a roller (e.g., the roller 360 of FIGS. 3 to 5, the roller 730 of FIGS. 7 to 9, the roller 1320 of FIGS. 13 and 14, or the roller 1530 of FIG. 15), a guide roller member (e.g., the guide roller member 340 of FIGS. 3 to 5, the guide roller member 740 of FIGS. 7 to 9, the support plate 1340 of FIGS. 13 and 14, or the guide roller member 1540 of FIG. 15), and a load transfer member (e.g., the load transfer member 350 of FIGS. 3 to 5, the load transfer member 750 of FIGS. 7 to 9, the load transfer member 1350 of FIGS. 13 and 14, or the load transfer member 1550 of FIG. 15). The pressure sensor 2023 may generate an electrical signal according to the degree of the received pressure. The electrical signal generated by the pressure sensor 2023 may be provided to the processor 2010.

The memory 2030 may store information required to control the overall operation of the cooking device 1 or to perform operations. According to an embodiment, the memory 2030 may store instructions that, when executed, enable the processor 2010 to control the cooling fan driving motor 2040 considering at least one of the internal temperature of the cavity, the operation mode, and/or the driving state. The memory 2030 may provide the corresponding operation data to the processor 2010 in response to an operation data request of the processor 2010.

The cooling fan driving motor 2040 may be operated by power supplied in response to control from the processor 2010. During operation, the cooling fan driving motor 2040 may rotate the cooling fan 1810 to supply air into the cooking device 1.

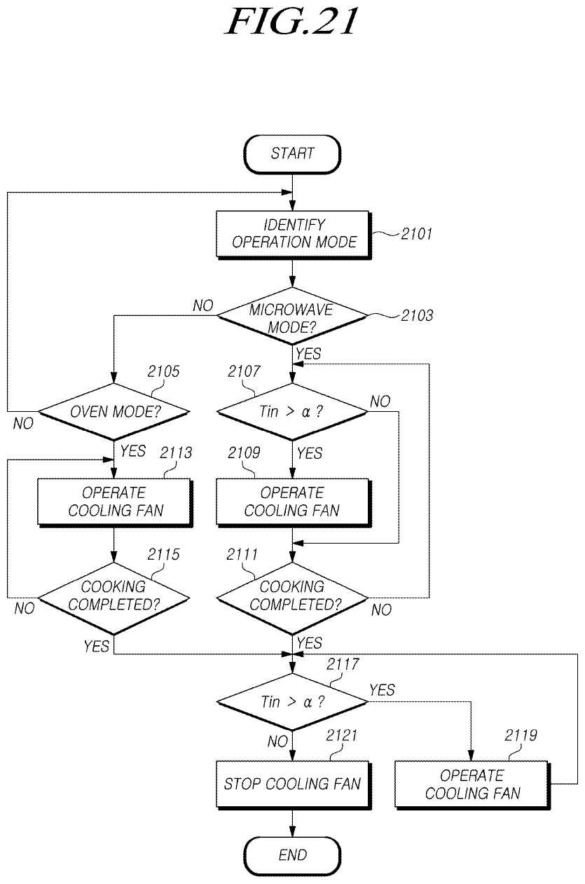

FIG. 21 is a flowchart illustrating controlling driving a cooling fan (e.g., the cooling fan 1810 of FIG. 18) in a cooking device (e.g., the cooking device 1 of FIG. 1).

Referring to FIG. 21, in operation 2101, the cooking device 1 may identify a set operation mode. The operation mode may be set by the user manipulating a button included on the front panel. The operation mode may be divided by a function that may be performed by the cooking device 1. The operation mode of the cooking device 1 may be set to one of, e.g., a microwave mode using microwaves, an oven mode using radiated radiant heat, or an air fryer mode using hot air.

In operation 2103 or 2105, the cooking device 1 may determine whether the operation mode is the microwave mode or the oven mode. When it is determined that the operation mode is the microwave mode, the cooking device 1 may perform operations 2107 to 2111. When it is determined that the operation mode is the oven mode, the cooking device 1 may perform operations 2113 and 2115.

When it is determined that the operation mode is the microwave mode, in operation 2107, the cooking device 1 may measure the internal temperature Tin of the cavity (e.g., the cavity 4 of FIG. 1) by a temperature sensor (e.g., the temperature sensor 2021 of FIG. 20), and may determine whether the measured temperature Tin is higher than a threshold temperature (a). When the measured temperature Tin is higher than the threshold temperature a, in operation 2109, the cooking device 1 may operate a cooling fan (e.g., the cooling fan 1810 of FIG. 18) such that external air is supplied to one or more sensors (e.g., the pressure sensor 2023 of FIG. 20) provided under the tray on which the cooking ingredient is placed to measure the load. When the measured temperature Tin is not higher than the threshold temperature a or after the cooling fan 1810 is operated, the cooking device 1 may determine whether cooking is completed in operation 2111. The cooking device 1 may repeatedly perform operations 2107 and 2109 until cooking is completed.

When it is determined that the operation mode is the oven mode, in operation 2113, the cooking device 1 may operate the cooling fan 1810 to supply outside air to a sensor provided under the tray on which the cooking ingredient is placed to measure the load. After operating the cooling fan 1810, the cooking device 1 may determine whether cooking is completed in operation 2115. The cooking device 1 may maintain the operation of the cooling fan 1810 in operation 2113 until cooking is completed.

When it is determined that the cooking is completed in operation 2111 or 2115, the cooking device 1 may measure the internal temperature Tin of the cavity by the temperature sensor and determine whether the measured temperature Tin is higher than the threshold temperature a in operation 2117. When the measured temperature Tin is higher than the threshold temperature a, in operation 2119, the cooking device 1 may operate the cooling fan 1810 such that external air is supplied to one or more pressure sensors provided under the tray on which the cooking ingredient is placed to measure the load. When the measured temperature Tin is not higher than the threshold temperature a, in operation 2121, the cooking device 1 may stop the operation of the cooling fan 1810 and then terminate the cooking operation according to the microwave mode or the oven mode.

As described above, according to an embodiment, the processor 1 may allow the cooling fan 1810 to operate when cooking is performed in the operation mode (e.g., the oven mode) in which direct heat is applied or until the internal temperature of the cavity drops below the set temperature even when cooking is completed, or may allow the cooling fan 1810 to operate only when the internal temperature of the cavity rises higher than the set temperature when operating in the operation mode (e.g., the microwave mode) in which no direct heat is applied.

The electronic device according to various embodiments of the disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

1. A cooking device, comprising:
a cavity including an opening;
a tray disposed to place a cooking ingredient on an upper surface thereof inside the cavity;
a guide roller member including a receiving tray in which a roller is mounted so as to be in rolling contact with a lower surface of the tray, and a guide rod extending in a vertical direction from a lower side of the receiving tray to a bottom of the cavity;
a load transfer member including a plate having a first coupling portion on an upper surface of the plate so as to have an upper opening, wherein a lower end portion of the guide rod is fitted and fixed in the first coupling portion;
a load cell having an upper surface in contact with a lower surface of the load transfer member, and configured to generate an electrical signal according to a load transferred through the guide rod and the load transfer member; and
a bracket including
at least two vertical surfaces that each has a fastening portion, at a first side end of the vertical surface, fastening the vertical surface with a lower surface of the cavity,
a horizontal surface forming a bottom of the bracket and horizontally connecting second side ends of the at least two vertical surfaces, and
a second coupling portion on the horizontal surface and having an upper opening,
wherein the plate and the load cell are inserted in the second coupling portion.

2. The cooking device of claim 1, wherein
the receiving tray is inside the cavity,
the load transfer member and the load cell are outside the cavity, and
the guide rod extends from the receiving tray, passes through the bottom of the cavity, and is inserted into the first coupling portion.

3. The cooking device of claim 1, wherein the guide rod has a hollow structure.

4. The cooking device of claim 1, wherein a size of a hole in the bottom of the cavity, through which the guide rod passes, is smaller than a wavelength of an electromagnetic wave generated in a microwave mode.

5. The cooking device of claim 1, wherein
the guide roller member, the load transfer member, and the load cell are under the bottom of the cavity, and
an upper end portion exposed outside the receiving tray in the roller mounted in the receiving tray passes through the bottom of the cavity and is in rolling contact with the lower surface of the tray.

6. The cooking device of claim 1, wherein
the guide rod has a hollow structure having a hole in a longitudinal direction of the guide rod,
the cooking device further includes an elastic member which has an upper end portion fitted into the hole of the guide rod and a lower end portion fitted into the first coupling portion.

7. The cooking device of claim 6, wherein the elastic member is a coil spring.

8. The cooking device of claim 1, wherein
the guide rod has a hollow structure having a hole in a longitudinal direction of the guide rod, and
the cooking device further includes a bolt which passes through a bottom of the first coupling portion and is inserted into the hole.

9. The cooking device of claim 1, further comprising:
a plurality of rollers mounted in the guide roller member, wherein
first side ends of two opposite side ends of load transfer members provided corresponding to the plurality of rollers, respectively, are gathered in a substantial center direction, and
the load cell is disposed at a position where the first side ends of the load transfer members are gathered.

10. The cooking device of claim 1, further comprising:
a cooling fan outside a ceiling of the cavity; and
a cooling passage having a first side end coupled with the cooling fan and a second side end disposed downward of the bottom of the cavity where the load cell is positioned to form a passage for supplying cooling air created by the cooling fan to the load cell.

11. The cooking device of claim 10, wherein a first side end of a cooling passage upper member is fitted into a first side end of a cooling passage lower member.

12. The cooking device of claim 1, wherein the roller has a wheel shape.

13. The cooking device of claim 1, wherein the roller has a ball shape.

14. A cooking device, comprising:
a cavity including an opening;
a tray disposed to place a cooking ingredient on an upper surface of the tray inside the cavity;
a support plate facing the tray and under the tray, and having a first coupling portion having a lower opening toward a bottom of the cavity in a lower surface of the support plate;
a plurality of rollers in rolling contact between the tray and the support plate;
a roller guide horizontally extending from a rotation shaft positioned in a substantial center of the tray and configured to allow the plurality of rollers to rotate along a predetermined concentric circle;
a guide injection-molded article having a second coupling portion with an upper opening and a predetermined length on an upper surface of a plate with a predetermined thickness, formed so that open surfaces of the second coupling portion and the first coupling portion are disposed to face each other on a vertical axis;
an elastic member having an upper end portion fitted into the first coupling portion and a lower end portion fitted over the second coupling portion; and
a load cell having the guide injection-molded article on an upper surface thereof so that a lower surface of the guide injection-molded article contacts the upper surface of the load cell, and configured to generate an electrical signal according to a load transferred through the support plate, the elastic member and the guide injection-molded article.

15. The cooking device of claim 14, further comprising:
a cell fixing member disposed between a lower surface of the load cell and a bottom and configured to support the load cell from the bottom.

16. The cooking device of claim 14, further comprising:
a protruding coupling portion fitted into a lower end of the elastic member near a center of the second coupling portion.

17. The cooking device of claim 16, wherein the protruding coupling portion has a rod shape or a button shape.

18. The cooking device of claim 14, further comprising:
a sensor housing that houses the guide injection-molded article and the load cell.

19. The cooking device of claim 18, wherein the sensor housing has a hole through which the second coupling portion passes upward along a vertical axis.

20. The cooking device of claim 14, wherein each roller of the plurality of rollers has a wheel shape or a ball shape.
